(19) United States
(12) Patent Application Publication
(10) Pub. No.: US 2024/0375378 A1
(43) Pub. Date: Nov. 14, 2024

(54) POLYMER INTERLAYERS WITH LOW MOTTLE AND REDUCED ICEFLOWER DEFECTS

(71) Applicant: SOLUTIA INC., ST. LOUIS, MO (US)

(72) Inventors: YINONG MA, LONGMEADOW, MA (US); KEYUAN HUANG, MOUNTAIN VIEW, CA (US)

(73) Assignee: SOLUTIA INC., ST. LOUIS, MO (US)

(21) Appl. No.: 18/688,831

(22) PCT Filed: Oct. 18, 2022
(86) PCT No.: PCT/US2022/046981

§ 371 Date: Mar. 4, 2024

Related U.S. Application Data
(60) Provisional application No. 63/262,702, filed on Oct. 19, 2021.

(51) Int. Cl. B32B 17/10; B32B 7/023; B32B 27/08; B32B 37/15

(52) U.S. Cl. CPC B32B 17/10577; B32B 7/023; B32B 27/08; B32B 37/153; B32B 2250/03; B32B 2250/24; B32B 2307/416; B32B 2307/51; B32B 2307/538

(57) ABSTRACT

A polymer interlayer that resists optical defects. The polymer interlayer comprises a first polymer layer and a second polymer layer. The first polymer layer is disposed on a first side of the second polymer layer. A non-embossed surface of the first side of the second polymer layer includes a surface roughness. defined by an Rz value, of greater than 40 microns. The polymer interlayer has a mottle value of less than 1.0.

### FIELD OF THE INVENTION

The present invention is related to the field of polymer interlayers and multiple layer panels comprising polymer interlayers. More specifically, the present invention is related to the field of polymer interlayers comprising multiple thermoplastic polymer layers.

### DESCRIPTION OF RELATED ART

Multiple layer panels are panels comprised of two sheets of a substrate (such as, but not limited to, glass, polyester, polyacrylate, or polycarbonate) with one or more polymer interlayers sandwiched therebetween. Laminated multiple layer glass panels are commonly utilized in architectural window applications and in the windows of motor vehicles and airplanes, and in photovoltaic solar panels. The first two applications are commonly referred to as laminated safety glass. The main function of the interlayer in the laminated safety glass is to absorb energy resulting from impact or force applied to the glass, to keep the layers of glass bonded even when the force is applied and the glass is broken, and to prevent the glass from breaking up into sharp pieces. Additionally, the interlayer may also give the glass a preferential sound insulation rating, reduce UV and/or IR light transmission, and enhance the aesthetic appeal of the associated window. For example, laminated glass panels with desirable acoustic properties have been produced, resulting in quieter internal spaces.

Furthermore, laminated glass panels been used in vehicles equipped with heads-up display (“HUD”) systems (also referred to as head-up systems), which project an image of an instrument cluster or other important information to a location on the windshield at the eye level of the vehicle operator. Such a display allows the driver to stay focused on the upcoming path of travel while visually accessing dashboard information. Generally, the HUD system in an automobile or an aircraft uses the inner surface of the vehicle windscreen to partially reflect the projected image. However, there is a secondary reflection taking place at the outside surface of the vehicle windscreen that forms a weak secondary image or “ghost” image. Since these two reflective images are offset in position, double images are often observed, which cause an undesirable viewing experience to the driver. When the image is projected onto a windshield which has a uniform and consistent thickness, the interfering double, or reflected ghost, image is created due to the differences in the position of the projected image as it is reflected off the inside and outside surfaces of the glass.

One method of addressing these double or ghost images is to orient the inner and outer glass sheets at an angle from one another. This aligns the position of the reflected images to a single point, thereby creating a single image. Typically, this is done by displacing the outer sheet relative to the inner sheet by employing a wedge-shaped, or “tapered,” interlayer that includes at least one region of nonuniform thickness. Many conventional tapered interlayers include a constant wedge angle over the entire HUD region, although some interlayers have recently been developed that include multiple wedge angles over the HUD region.

In order to achieve the required property and performance characteristics for glass panels, it has become common practice to utilize multiple layer or multilayered interlayers. As used herein, the terms “multilayer” and “multiple layers” mean an interlayer having more than one layer, and multilayer and multiple layer may be used interchangeably. Multiple layer interlayers typically contain at least one soft layer and at least one stiff layer. As noted above, interlayers with one soft “core” layer sandwiched between two more rigid or stiff “skin” layers have been designed with sound insulation properties for the glass panel. Interlayers having the reverse configuration, that is, with one stiff layer sandwiched between two more soft layers have been found to improve the impact performance of the glass panel and can also be designed for sound insulation. Regardless, the soft “core” layer is generally referred to as an acoustic layer (as the soft layer beneficially reduces sound transmission), while the hard “skin” layers are referred to as conventional layers, or non-acoustic layers.

The layers of the interlayer are generally produced by mixing a polymer resin such as poly(vinyl butyral) with one or more plasticizers and melt processing the mix into a sheet by any applicable process or method known to one of skill in the art, including, but not limited to, extrusion, with the layers being combined by processes such as co-extrusion and lamination. In a trilayer interlayer, the core layer may include more plasticizer than the skin layers, such that the core layer is softer than the relatively harder skin layers. Other additional ingredients may optionally be added for various other purposes. After the interlayer sheet is formed, it is typically collected and rolled for transportation and storage and for later use in the multiple layer glass panel, as discussed below.

The following offers a simplified description of the manner in which multiple layer glass panels are generally produced in combination with the interlayers. First, a multiple layer interlayer may be co-extruded using a multiple manifold co-extrusion device. The device operates by simultaneously extruding polymer melts from each manifold toward an extrusion opening. Properties of the layers can be varied by adjusting attributes (e.g., temperature and/or opening dimensions) of the die lips at the extrusion opening. Once formed, the interlayer sheet can be placed between two glass substrates and any excess interlayer is trimmed from the edges, creating an assembly. It is not uncommon for multiple polymer interlayer sheets or a polymer interlayer sheet with multiple layers (or a combination of both) to be placed within the two glass substrates creating a multiple layer glass panel with multiple polymer interlayers. Then, air is removed from the assembly by an applicable process or method known to one of skill in the art; e.g., through nip rollers, vacuum bag or another deairing mechanism. Additionally, the interlayer is partially press-bonded to the substrates by any method known to one of ordinary skill in the art. In a last step, in order to form a final unitary structure, this preliminary bonding is rendered more permanent by a high temperature and pressure lamination process, or any other method known to one of ordinary skill in the art such as, but not limited to, autoclaving.

Multilayer interlayers such as a trilayer interlayer having a soft core layer and two stiffer skin layers are known to provide beneficial acoustic damping properties. However, glass panels containing these multilayered acoustic interlayers can, under extreme conditions, develop defects commonly known as iceflowers (also known as snowflakes), which initiate in the presence of excessive residual, trapped air in the panels and stress in the glass. Specifically, during the manufacturing process of laminated multiple layer glass panel constructs, air and other gasses often become trapped in the interstitial spaces between the substrates and the interlayer or between the individual layers of the multilayered interlayer when these layers are stacked together to form the multilayered interlayer. This trapped air is generally removed in the glazing or panel manufacturing process by vacuum or nip roll de-airing the construct. However, these technologies are not always effective in removing all of the air trapped in the interstitial spaces between the substrates. These pockets of air are particularly evident with mismatched glass (e.g., tempered glass, heat strengthened glass, and thick, annealed glass) and in windshields, where the curvature of the glass generally results in gaps of air. These gaps of air in windshields are commonly referred to as “bending gaps.” Additionally, when a bending gap is present during autoclaving, heat and pressure compress the glass to conform to the interlayer and narrow the gap, resulting in high stresses in the glass in the original gap area.

As noted above, the de-airing technologies are not always effective in removing all of the air from the glass panel assembly. As a result, there is residual air present between the glass and interlayer. During autoclaving, the residual air dissolves into the interlayer, mostly in the skin layer, under heat and pressure. The residual air located in the skin layer can move into the core layer or skin-core interface, and it eventually partitions between skin layer and core layer to reach an equilibrium state. When a large amount of residual air (e.g., excessive residual air) is present in the interlayer, air bubbles can nucleate, especially at high temperatures, as the interlayer becomes soft and is less resistant to the nucleation.

With multilayer acoustic interlayers having a soft core layer sandwiched by two stiffer skin layers, e.g., the soft layer is constrained between two stiffer layers, air bubbles commonly first form within the soft core layer as nucleation favors the less viscous medium. In warm to hot climates, such as during the summer season, the temperature of glass can elevate to 50° C. to 100° C. in the laminated glass installed on buildings and vehicles. At these elevated temperatures, forces due to stresses in glass panels or windshields exert pressure on the glass perpendicularly to their plane and in the opposite direction, pulling the glass panels away from each other in an effort to restore them to their original states. The stress reduces the resistance of the air to nucleate and expand and allows the bubble to grow within the core layer.

At elevated temperatures (e.g., 50° C. to 100° C.), the stresses from the bending gap or glass mismatch cause the bubbles to expand in the path of least resistance in random radial directions within the core layer. As the defects continue radial expansion, branches and dendritic-like features form, and give the undesirable optical appearance of iceflowers. Additionally, the formation of iceflowers within the core layer typically leads to a separation between the layers, reducing the structural integrity of the panel.

Additional problems in the manufacture of multilayer laminate glass panels is the presence of mottle in the final unitary structure. The term “mottle” refers to an objectionable visual defect in the final unitary structure, namely the appearance of uneven spots. Stated differently, mottle is a measure of the graininess or texture of the surface area of the inner polymer interlayer or polymer interlayers. It is a form of optical distortion. It is believed that mottle is caused by small scale surface variations of the interfaces between layers of the laminate having different refractive indices. The refractive index of a layer is the measure of the speed of light through that substance. Mottle is theoretically possible with any multiple layer interlayer provided that there is a sufficiently large difference in the refractive index between the layers and there is some degree of interfacial variation. The presence of mottle in the final unitary structure of a multilayer laminate glass panel can be problematic because a certain degree of optical quality is necessary in many (if not most) of the end-use commercial applications of multilayer laminate glass panels (e.g., vehicular, aeronautical and architectural applications).

In view of the above, there is a need in the art for the development of a multilayered interlayer that resists the formation of these optical defects (i.e., iceflowers and mottle) without a reduction in other optical, mechanical, and acoustic characteristics of a conventional multilayered interlayer. More specifically, there is a need in the art for the development of multilayered interlayers having at least one soft core layer and one stiff skin layer that resists air nucleation and expansion to form iceflowers while also having acceptable mottle values.

### BRIEF DESCRIPTION OF THE DRAWINGS

FIG. 1 is a schematic illustration of a glass laminate panel comprising a pair of glass plates opposing a polymer interlayer, with the polymer interlayer comprising a trilayer with a pair of skin layers opposing a core layer;

FIG. 2 is another schematic illustration of a glass laminate panel comprising a pair of glass plates opposing a polymer interlayer, with the polymer interlayer having a wedge shape;

FIG. 3 is a schematic cross-section of a co-extrusion die having an opening defined by the die and/or by a pair of die lips, with the die configured to co-extrude a multilayer polymer interlayer;

FIG. 4 is a magnified view of a polymer interlayer with a regular surface roughness pattern, in the form of a tire-track pattern, formed on a surface of the polymer interlayer by melt fracture;

FIG. 5 is a magnified view of a polymer interlayer with a random surface pattern formed on a surface of the polymer interlayer;

FIG. 6 is a photograph of a plurality of stacked inventive trilayer interlayers formed according to embodiments of the present invention, with the inventive trilayer interlayers illustrating a lack of iceflower formation; and

FIG. 7 is a photograph of a plurality of stacked control trilayer interlayers formed according to a prior art process, with the control trilayer interlayers illustrating a presence of iceflower formation.

### SUMMARY

One aspect of the present invention concerns a polymer interlayer that resists formation of optical defects. The polymer interlayer comprises a first polymer layer and a second polymer layer. The first polymer layer is disposed on a first side of the second polymer layer. A non-embossed surface of the first side of the second polymer layer includes a surface roughness, defined by an R_{Z} value, of greater than 40 microns. The polymer interlayer has a mottle value of less than 1.0.

Another aspect of the present invention concerns a polymer interlayer that resists formation of optical defects. The polymer interlayer comprises a first polymer layer, and a second polymer layer. The first polymer layer is disposed on a first side of said second polymer layer. A surface of the first side of the second polymer layer includes a surface roughness, defined by an R_{SM} value, of greater than 500 microns. The polymer interlayer has a mottle value of less than 1.0.

A further aspect of the present invention concerns an additional method of making a polymer interlayer that resists formation of optical defects. One step of the method includes extruding a first polymer layer through a co-extrusion die. An additional step includes extruding a second polymer layer through the co-extrusion die. A further step includes extruding a third polymer layer through the co-extrusion die. Upon the extruding steps, the first polymer layer is positioned between the second and third polymer layers. During the extruding of the first polymer layer, the first polymer layer has a first storage modulus value. During the extruding of the second polymer layer, the second polymer layer has a second storage modulus value. A difference between the first storage modulus value and the second storage modulus value is less than about 45,000 Pa. After the first, second, and third polymer layers have been extruded, the polymer interlayer has a mottle value of less than 1.0.

A further aspect of the present invention concerns a polymer interlayer that resists formation of optical defects formed using a method including the following steps. One step includes extruding a first polymer layer through a co-extrusion die. An additional step includes extruding a second polymer layer through the co-extrusion die. A further step includes extruding a third polymer layer through the co-extrusion die. Upon the extruding steps, the first polymer layer is positioned between the second and third polymer layers. During the extruding of the first polymer layer, the first polymer layer has a first storage modulus value. During the extruding of the second polymer layer, the second polymer layer has a second storage modulus value. A difference between the first storage modulus value and the second storage modulus value is less than about 45,000 Pa. After the first, second, and third polymer layers have been extruded, the polymer interlayer has a mottle value of less than 1.0.

### DETAILED DESCRIPTION

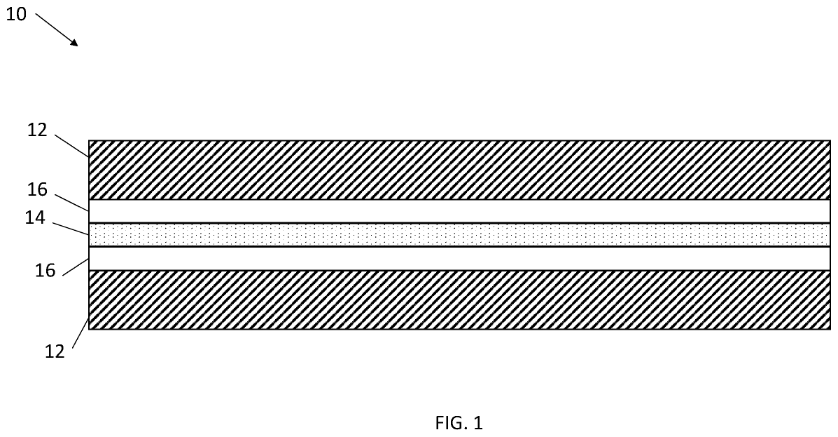

Embodiments of the present invention are directed to multiple layer panels and methods of making multiple layer panels. Generally, multiple layer panels are comprised of two sheets of glass, or other applicable substrates, with a polymer interlayer sheet or sheets sandwiched there-between. Multiple layer panels are generally produced by placing at least one polymer interlayer sheet between two substrates to create an assembly. FIG. 1 illustrates a multiple layer panel 10 comprising a pair of glass sheets 12 with a multilayered interlayer sandwiched therebetween. The multilayered interlayer is configured as a trilayer interlayer having three individual polymer interlayer sheets, including a soft core layer 14 and two relatively stiffer skin layers 16 positioned on either side of the core layer 14.

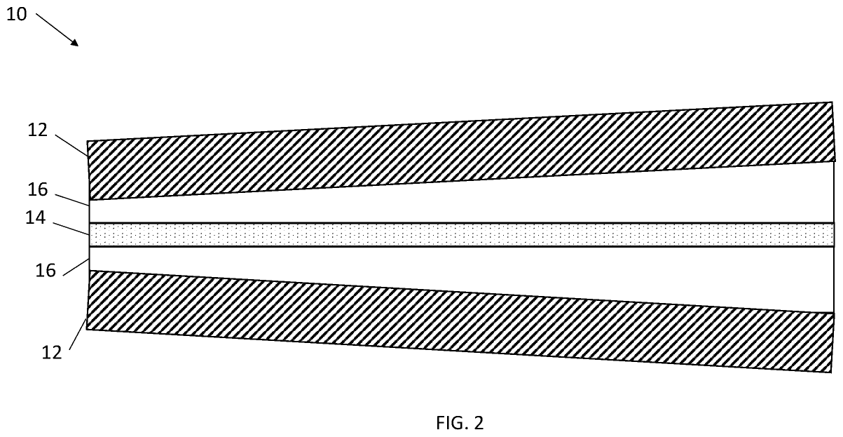

In some embodiments, the interlayer (e.g., the core layer 14 and the skin layers 16) will have a generally constant or uniform thickness about the length of the interlayer. However, in alternative embodiments, as shown in FIG. 2, the interlayer may have at least one region of non-uniform thickness. For example, the interlayer, comprised of the core layer 14 and skin layers 16, may be wedge-shaped, such that the thickness of the interlayer changes (e.g., linearly or non-linearly) about the length of the interlayer. In some such embodiments, the thickness of the interlayer may change due to a thickness change in the core layer 14 (i.e., with the skin layers 16 having a generally constant thickness). Alternatively, the thickness of the interlayer may change due to a thickness change in the skin layers 16 (i.e., with the core layer 14 having a generally constant thickness). In further alternatives, the thickness of the interlayer may change due to a thickness change in both the core layer 14 and the skin layers 16.

In order to facilitate a more comprehensive understanding of the interlayers and multiple layer panels disclosed herein, the meaning of certain terms, as used in this application, will be defined. These definitions should not be taken to limit these terms as they are understood by one of ordinary skill, but simply to provide for improved understanding of how certain terms are used herein.

The terms “polymer interlayer sheet,” “interlayer,” “polymer layer”, and “polymer melt sheet” as used herein, may designate a single-layer sheet or a multilayered interlayer. A “single-layer sheet,” as the names implies, is a single polymer layer extruded as one layer. A multilayered interlayer, on the other hand, may comprise multiple layers, including separately extruded layers, co-extruded layers, or any combination of separately and co-extruded layers. Thus, the multilayered interlayer could comprise, for example: two or more single-layer sheets combined together (“plural-layer sheet”); two or more layers co-extruded together (“co-extruded sheet”); two or more co-extruded sheets combined together; a combination of at least one single-layer sheet and at least one co-extruded sheet; and a combination of at least one plural-layer sheet and at least one co-extruded sheet. In various embodiments of the present invention, a multilayered interlayer comprises at least two polymer layers (e.g., a single layer or multiple layers co-extruded) disposed in direct contact with each other, wherein each layer comprises a polymer resin. The term “resin,” as utilized herein refers to the polymeric component (e.g., PVB) removed from the processes, such as those discussed more fully below. Generally, plasticizer, such as those discussed more fully below, is added to the resins to result in a plasticized polymer. Additionally, resins may have other components in addition to the polymer and plasticizer as further discussed below.

It should also be noted that while poly (vinyl butyral) (“PVB”) interlayers are often specifically discussed as the polymer resin of the polymer interlayers in this application, it should be understood that other thermoplastic interlayers besides PVB interlayers may be used. Contemplated polymers include, but are not limited to, polyurethane, polyvinyl chloride, poly(ethylene vinyl acetate) and combinations thereof. These polymers can be utilized alone, or in combination with other polymers. Accordingly, it should be understood that when ranges, values and/or methods are given for a PVB interlayer in this application (e.g., plasticizer component percentages, thickness and characteristic-enhancing additives), those ranges, values and/or methods also apply, where applicable, to the other polymers and polymer blends disclosed herein or could be modified, as would be known to one of ordinary skill, to be applied to different materials.

As used herein, the term “molecular weight” refers to weight average molecular weight (Mw). The molecular weight of the PVB resin can be in the range of from about 50,000 to about 600,000, about 70,000 to about 450,000, or about 100,000 to about 425,000 Daltons. Furthermore, in some embodiments, it may be preferable for one or more of the polymer layers of the interlayer to have a unimodal Mw distribution. For example, it may be preferable for the skin layers to be formed from a PVB resin that includes a unimodal Mw distribution, as such resins may aid in the generation of regular melt fraction patterns, as will be discussed below.

The PVB resin may be produced by known aqueous or solvent acetalization processes by reacting polyvinyl alcohol (“PVOH”) with butyraldehyde in the presence of an acid catalyst, separation, stabilization, and drying of the resin. Such acetalization processes are disclosed, for example, in U.S. Pat. Nos. 2,282,057 and 2,282,026 and Wade, B. (2016), “Vinyl Acetal Polymers”, Encyclopedia of Polymer Science and Technology, pp. 1-22 (John Wiley & Sons, Inc.), the entire disclosures of which are incorporated herein by reference.

While generally referred herein as “poly(vinyl acetal)” or “poly(vinyl butyral)”, the resins described herein may include residues of any suitable aldehyde, including, but not limited to, isobutyraldehyde, as previously discussed. In some embodiments, one or more poly (vinyl acetal) resin can include residues of at least one C₁ to C₁₀ aldehyde, or at least one C₄ to C₈ aldehyde. Examples of suitable C₄ to C₈ aldehydes can include, but are not limited to, n-butyraldehyde, isobutyraldehyde, 2-methylvaleraldehyde, n-hexyl aldehyde, 2-ethylhexyl aldehyde, n-octyl aldehyde, and combinations thereof.

In many embodiments, plasticizers are added to the polymer resin to form polymer layers or interlayers. Plasticizers are generally added to the polymer resin to increase the flexibility and durability of the resultant polymer interlayer. Plasticizers function by embedding themselves between chains of polymers, spacing them apart (increasing the “free volume”) and thus significantly lowering the glass transition temperature (T_{g}) of the polymer resin, making the material softer. In this regard, the amount of plasticizer in the interlayer can be adjusted to affect the glass transition temperature (T_{g}). The glass transition temperature (T_{g}) is the temperature that marks the transition from the glassy state of the interlayer to the rubbery state. In general, higher amounts of plasticizer loading can result in lower T_{g}.

Contemplated plasticizers include, but are not limited to, esters of a polybasic acid, a polyhydric alcohol, triethylene glycol di-(2-ethylbutyrate), triethylene glycol di-(2-ethylhexonate) (known as “3-GEH”), triethylene glycol diheptanoate, tetraethylene glycol diheptanoate, dihexyl adipate, dioctyl adipate, hexyl cyclohexyladipate, mixtures of heptyl and nonyl adipates, diisononyl adipate, heptylnonyl adipate, dibutyl sebacate, and polymeric plasticizers such as oil-modified sebacic alkyds and mixtures of phosphates and adipates, and mixtures and combinations thereof. 3-GEH is particularly preferred. Other examples of suitable plasticizers can include, but are not limited to, tetraethylene glycol di-(2-ethylhexanoate) (“4-GEH”), di(butoxyethyl) adipate, and bis(2-(2-butoxyethoxy)ethyl)adipate, dioctyl sebacate, nonylphenyl tetraethylene glycol, and mixtures thereof.

Other suitable plasticizers may include blends of two or more distinct plasticizers, including but not limited to those plasticizers described above. Still other suitable plasticizers, or blends of plasticizers, may be formed from aromatic groups, such polyadipates, epoxides, phthalates, terephthalates, benzoates, toluates, mellitates and other specialty plasticizers. Further examples include, but are not limited to, dipropylene glycol dibenzoate, tripropylene glycol dibenzoate, polypropylene glycol dibenzoate, isodecyl benzoate, 2-ethylhexyl benzoate, diethylene glycol benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, di-2-ethylhexyl terephthalate, bis-phenol A bis(2-ethylhexaonate), ethoxylated nonylphenol, and mixtures thereof. In some embodiments, the plasticizer can be selected from the group consisting of dipropylene glycol dibenzoates, tripropylene glycol dibenzoates, and combinations thereof.

Generally, the plasticizer content of the polymer interlayers of this application are measured in parts per hundred resin parts (“phr”), on a weight per weight basis. For example, if 30 grams of plasticizer is added to 100 grams of polymer resin, the plasticizer content of the resulting plasticized polymer would be 30 phr. When the plasticizer content of a polymer layer is given in this application, the plasticizer content of the particular layer is determined in reference to the phr of the plasticizer in the melt that was used to produce that particular layer. In some embodiments, the high rigidity interlayer comprises a layer having a plasticizer content of less than about 35 phr and less than about 30 phr.

According to some embodiments of the present invention, one or more polymer layers described herein can have a total plasticizer content of at least about 20 phr, at least about 25 phr, at least about 30 phr, at least about 35 phr, at least about 38 phr, at least about 40 phr, at least about 45 phr, at least about 50 phr, at least about 55 phr, at least about 60 phr, at least about 65 phr, at least about 67 phr, at least about 70 phr, at least about 75 phr of one or more plasticizers. In some embodiments, the polymer layer may also include not more than about 100 phr, not more than about 85 phr, not more than 80 phr, not more than about 75 phr, not more than about 70 phr, not more than about 65 phr, not more than about 60 phr, not more than about 55 phr, not more than about 50 phr, not more than about 45 phr, not more than about 40 phr, not more than about 38 phr, not more than about 35 phr, or not more than about 30 phr of one or more plasticizers. In some embodiments, the total plasticizer content of at least one polymer layer can be in the range of from about 20 to about 40 phr, about 20 to about 38 phr, or about 25 to about 35 phr. In other embodiments, the total plasticizer content of at least one polymer layer can be in the range of from about 38 to about 90 phr, about 40 to about 85 phr, or about 50 to 70 phr.

When the interlayer includes a multiple layer interlayer, two or more polymer layers within the interlayer may have the substantially the same plasticizer content and/or at least one of the polymer layers may have a plasticizer content different from one or more of the other polymer layers. When the interlayer includes two or more polymer layers having different plasticizer contents, the two layers may be adjacent to one another. In some embodiments, the difference in plasticizer content between adjacent polymer layers can be at least about 1, at least about 2, at least about 5, at least about 7, at least about 10, at least about 20, at least about 30, at least about 35 phr and/or not more than about 80, not more than about 55, not more than about 50, or not more than about 45 phr, or in the range of from about 1 to about 60 phr, about 10 to about 50 phr, or about 30 to 45 phr. When three or more layers are present in the interlayer, at least two of the polymer layers of the interlayer may have similar plasticizer contents falling for example, within 10, within 5, within 2, or within 1 phr of each other, while at least two of the polymer layers may have plasticizer contents differing from one another according to the above ranges.

In some embodiments, one or more polymer layers or interlayers described herein may include a blend of two or more plasticizers including, for example, two or more of the plasticizers listed above. When the polymer layer includes two or more plasticizers, the total plasticizer content of the polymer layer and the difference in total plasticizer content between adjacent polymer layers may fall within one or more of the ranges above. When the interlayer is a multiple layer interlayer, one or more than one of the polymer layers may include two or more plasticizers. In some embodiments when the interlayer is a multiple layer interlayer, at least one of the polymer layers including a blend of plasticizers may have a glass transition temperature higher than that of conventional plasticized polymer layer. This may provide, in some cases, additional stiffness to layer which can be used, for example, as an outer “skin” layer in a multiple layer interlayer.

In addition to plasticizers, it is also contemplated that adhesion control agents (“ACAs”) can also be added to the polymer resins to form polymer interlayers. ACAs generally function to alter the adhesion to the interlayer. Contemplated ACAs include, but are not limited to, the ACAs disclosed in U.S. Pat. No. 5,728,472, residual sodium acetate, potassium acetate, and/or magnesium bis(2-ethyl butyrate).

Other additives may be incorporated into the interlayer to enhance its performance in a final product and impart certain additional properties to the interlayer. Such additives include, but are not limited to, dyes, pigments, stabilizers (e.g., ultraviolet stabilizers), antioxidants, anti-blocking agents, flame retardants, IR absorbers or blockers (e.g., indium tin oxide, antimony tin oxide, lanthanum hexaboride (LaB₆) and cesium tungsten oxide), processing aides, flow enhancing additives, lubricants, impact modifiers, nucleating agents, thermal stabilizers, UV absorbers, UV stabilizers, dispersants, surfactants, chelating agents, coupling agents, adhesives, primers, reinforcement additives, and fillers, among other additives known to those of ordinary skill in the art.

One parameter used to describe the polymer resin components of the polymer interlayers of this application is residual hydroxyl content (as vinyl hydroxyl content or poly (vinyl alcohol) (“PVOH”) content). Residual hydroxyl content refers to the amount of hydroxyl groups remaining as side groups on the chains of the polymer after processing is complete. For example, PVB can be manufactured by hydrolyzing poly(vinyl acetate) to poly(vinyl alcohol), and then reacting the poly(vinyl alcohol) with butyraldehyde to form PVB. In the process of hydrolyzing the poly(vinyl acetate), typically not all of the acetate side groups are converted to hydroxyl groups. Further, the reaction with butyraldehyde typically will not result in all of the hydroxyl groups being converted into acetal groups. Consequently, in any finished PVB, there will typically be residual acetate groups (such as vinyl acetate groups) and residual hydroxyl groups (such as vinyl hydroxyl groups) as side groups on the polymer chain. Generally, the residual hydroxyl content of a polymer can be regulated by controlling the reaction times and reactant concentrations, among other variables in the polymer manufacturing process. When utilized as a parameter herein, the residual hydroxyl content is measured on a weight percent basis per ASTM D-1396.

In various embodiments, the poly (vinyl butyral) resin comprises about 8 to about 35 weight percent (wt. %) residual hydroxyl groups calculated as PVOH, about 13 to about 30 wt. % residual hydroxyl groups calculated as PVOH, about 8 to about 22 wt. % residual hydroxyl groups calculated as PVOH, or about 15 to about 22 wt. % residual hydroxyl groups calculated as PVOH; and for some of the high rigidity interlayers disclosed herein, for one or more of the layers, the poly (vinyl butyral) resin comprises greater than about 19 wt. % residual hydroxyl groups calculated as PVOH, greater than about 20 wt. % residual hydroxyl groups calculated as PVOH, greater than about 20.4 wt. %

residual hydroxyl groups calculated as PVOH, and greater than about 21 wt. % residual hydroxyl groups calculated as PVOH.

In some embodiments, the poly (vinyl butyral) resin used in at least one polymer layer of an interlayer may include a poly (vinyl butyral) resin that has a residual hydroxyl content of at least about 18, at least about 18.5, at least about 18.7, at least about 19, at least about 19.5, at least about 20, at least about 20.5, at least about 21, at least about 21.5, at least about 22, at least about 22.5 wt. % and/or not more than about 30, not more than about 29, not more than about 28, not more than about 27, not more than about 26, not more than about 25, not more than about 24, not more than about 23, or not more than about 22 wt. %, measured as described above.

Additionally, one or more other polymer layers in the interlayers described herein may include another poly (vinyl butyral) resin that has a lower residual hydroxyl content. For example, in some embodiments, at least one polymer layer of the interlayer can include a poly (vinyl butyral) resin having a residual hydroxyl content of at least about 8, at least about 8.5, at least about 9, at least about 9.5, at least about 10, at least about 10.5, at least about 11, at least about 11.5, at least about 12, at least about 13 wt. % and/or not more than about 16, not more than about 15, not more than about 14, not more than about 13.5, not more than about 13, not more than about 12, or not more than about 11.5 wt. %, measured as described above.

When the interlayer includes two or more polymer layers, the layers may include poly(vinyl butyral) resins that have substantially the same residual hydroxyl content, or the residual hydroxyl contents of the poly(vinyl butyral) resins in each layer may differ from each other. When two or more layers include poly(vinyl butyral) resins having substantially the same residual hydroxyl content, the difference between the residual hydroxyl contents of the poly (vinyl butyral) resins in each layer may be less than about 2, less than about 1, or less than about 0.5 wt. %. As used herein, the terms “weight percent different” and “the difference between . . . is at least . . . weight percent” refer to a difference between two given weight percentages, calculated by subtracting one number from the other. For example, a poly (vinyl acetal) resin having a residual hydroxyl content of 12 wt. % has a residual hydroxyl content that is 2 wt. % different than a poly (vinyl acetal) resin having a residual hydroxyl content of 14 wt. % (14 wt. %−12 wt. %=2 wt. %). As used herein, the term “different” can refer to a value that is higher than or lower than another value. Unless otherwise specified, all “differences” herein refer to the numerical value of the difference and not to the specific sign of the value due to the order in which the numbers were subtracted. Accordingly, unless noted otherwise, all “differences” herein refer to the absolute value of the difference between two numbers.

When two or more layers include poly (vinyl butyral) resins having different residual hydroxyl contents, the difference between the residual hydroxyl contents of the poly (vinyl butyral) resins can be at least about 2, at least about 3, at least about 4, at least about 5, at least about 6, at least about 7, at least about 8, at least about 9, at least about 10, at least about 12, at least about 15 wt. %, measured as described above.

The resin can also comprise less than 35 wt. % residual ester groups, less than 30 wt. %, less than 25 wt. %, less than 15 wt. %, less than 13 wt. %, less than 11 wt. %, less than 9 wt. %, less than 7 wt. %, less than 5 wt. %, or less than 1 wt. % residual ester groups calculated as polyvinyl ester, e.g., acetate, with the balance being an acetal, preferably butyraldehyde acetal, but optionally including other acetal groups in a minor amount, for example, a 2-ethyl hexanal group (see, for example, U.S. Pat. No. 5,137,954, the entire disclosure of which is incorporated herein by reference). The residual acetate content of a resin may also be determined according to ASTM D-1396.

According to some embodiments, the difference between the glass transition temperatures of two polymer layers, typically adjacent polymer layers within an interlayer, can be at least about 5, at least about 10, at least about 15, at least about 20, at least about 25, at least about 30, at least about 35, at least about 40, or at least about 45° C., while in other embodiments, two or more polymer layers can have a glass transition temperature within about 5, about 3, about 2, or about 1° C. of each other. Generally, the lower glass transition temperature layer has a lower stiffness than the higher glass transition temperature layer or layers in an interlayer and may be located between higher glass transition temperature polymer layers in the final interlayer construction.

For example, in some embodiments of this application, the increased acoustic attenuation properties of soft layers are combined with the mechanical strength of stiff/rigid layers to create a multilayered interlayer. In these embodiments, a central soft layer is sandwiched between two stiff/rigid outer layers. This configuration of (stiff)/(soft)//(stiff) creates a multilayered interlayer that is easily handled, can be used in conventional lamination methods and that can be constructed with layers that are relatively thin and light. The soft layer is generally characterized by a lower residual hydroxyl content (e.g., less than or equal to 16 wt. %, less than or equal to 15 wt. %, or less than or equal to 12 wt. % or any of the ranges disclosed above), a higher plasticizer content (e.g., greater than or equal to about 48 phr or greater than or equal to about 70 phr, or any of the ranges disclosed above) and/or a lower glass transition temperature (e.g., less than 30° C. or less than 10° C., or any of the ranges disclosed above).

It is contemplated that polymer interlayer sheets as described herein may be produced by any suitable process known to one of ordinary skill in the art of producing polymer interlayer sheets that are capable of being used in a multiple layer panel (such as a glass laminate). For example, it is contemplated that the polymer interlayer sheets may be formed through solution casting, compression molding, injection molding, melt extrusion, melt blowing or any other procedures for the production and manufacturing of a polymer interlayer sheet known to those of ordinary skill in the art. Further, in embodiments where multiple polymer interlayers are utilized, it is contemplated that these multiple polymer interlayers may be formed through co-extrusion, blown film, dip coating, solution coating, blade, paddle, air-knife, printing, powder coating, spray coating or other processes known to those of ordinary skill in the art. While all methods for the production of polymer interlayer sheets known to one of ordinary skill in the art are contemplated as possible methods for producing the polymer interlayer sheets described herein, this application will focus on polymer interlayer sheets produced through extrusion and/or co-extrusion processes. The final multiple layer glass panel laminate of the present disclosure can be formed using processes known in the art.

In the extrusion process, thermoplastic resin and plasticizers, including any of those resins and plasticizers described above, are generally pre-mixed and fed into an extruder device. Additives such as colorants and UV inhibitors (in liquid, powder, or pellet form) may be used and can be mixed into the thermoplastic resin or plasticizer prior to arriving in the extruder device. These additives are incorporated into the thermoplastic polymer resin, and by extension the resultant polymer interlayer sheet, to enhance certain properties of the polymer interlayer sheet and its performance in the final multiple layer glass panel product.

In the extruder device, the particles of the thermoplastic raw material and plasticizers, including any of those resins, plasticizers, and other additives described above, are further mixed and melted, resulting in a melt that is generally uniform in temperature and composition. Once the melt reaches the end of the extruder device, the melt is propelled into the extruder die. The extruder die is the component of the extruder device which gives the final polymer interlayer sheet product its profile. The die will generally have an opening, defined by a lip, that is substantially greater in one dimension than in a perpendicular dimension. Generally, the die is designed such that the melt evenly flows from a cylindrical profile coming out of the die and into the product's end profile shape. A plurality of shapes can be imparted to the end polymer interlayer sheet by the die so long as a continuous profile is present. Generally, in its most basic sense, extrusion is a process used to create objects of a fixed cross-sectional profile. This is accomplished by pushing or drawing a material through a die of the desired cross-section for the end product.

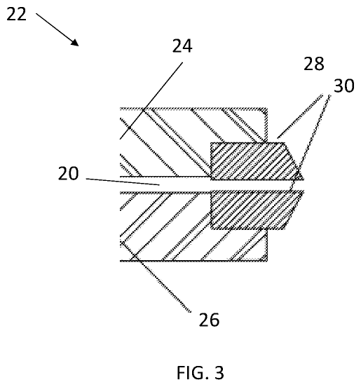

In some embodiments, a co-extrusion process may be utilized. Co-extrusion is a process by which multiple layers of polymer material are extruded simultaneously. Generally, this type of extrusion utilizes two or more extruders to melt and deliver a steady volume throughput of different thermoplastic melts of different viscosities or other properties through a co-extrusion die into the desired final form. For example, the multiple layer interlayers of the present invention (e.g., in the form of a trilayer interlayer) may be preferably co-extruded using a multiple manifold co-extrusion device which includes a first die manifold, a second die manifold, and a third die manifold. The co-extrusion device may, as illustrated by FIG. 3, operate by simultaneously extruding polymer melts from each manifold converging three extrusion melt streams to a single opening 20 of a die 22 of the co-extrusion device. The opening 20 may be defined, at least partially, as a space or gap present between a first portion 24 (e.g., an upper portion) and a second portion 26 (e.g., a lower portion) of the die 22. In some embodiments, the opening 20 may further be defined by a pair of spaced apart die lips (i.e., a first die lip 28 and a second die lip 30) positioned at an outlet of the opening 20. As such, the co-extrusion device can be configured to extrude a trilayer interlayer comprising a composite of three individual polymer layers (e.g., a core layer 14 sandwiched between a pair of skin layers 16). In particular, the composite trilayer interlayer can be co-extruded through the opening 20, with a first skin layer 16 being positioned adjacent to the first portion 24 (e.g., the upper portion) and/or the first die lip 28 (e.g., an upper die lip) of the die 22, a second skin layer 16 being positioned adjacent to the second portion 26 (e.g., the lower portion) and/or the second die lip 30 (e.g., a lower die lip) of the die 22, and the core layer 14 being co-extruded through the die 22 sandwiched between the two skin layers 16. As such, during co-extrusion, the core layer 14 will not generally contact either the first or second portions 24, 26 and/or the first or second die lips 28, 30 of the die 22.

The thickness of the multiple polymer layers leaving the extrusion die 22 in the co-extrusion process can generally be controlled by adjustment of the relative speeds of the melt through the extrusion die 22 and/or by adjusting the sizes of the die opening 20. In certain embodiments, the positions of one or both of the die lips 28, 30 may be shifted with respect to each other so as to increase or decrease the size of the opening 20. According to some embodiments, the total thickness of the multiple layer interlayer can be at least about 13 mils, at least about 20, at least about 25, at least about 27, at least about 30, at least about 31 mils and/or not more than about 75, not more than about 70, not more than about 65, not more than about 60 mils, or it can be in the range of from about 13 to about 75 mils, about 25 to about 70 mils, or about 30 to 60 mils. When the interlayer comprises two or more polymer layers, each of the layers can have a thickness of at least about 2, at least about 3, at least about 4, at least about 5, at least about 6, at least about 7, at least about 8, at least about 9, at least about 10 mils and/or not more than about 50, not more than about 40, not more than about 30, not more than about 20, not more than about 17, not more than about 15, not more than about 13, not more than about 12, not more than about 10, not more than about 9 mils. In some embodiments, each of the layers may have approximately the same thickness, while in other embodiments, one or more layers may have a different thickness than one or more other layers within the interlayer.

In some embodiments wherein the interlayer comprises at least three polymer layers, one or more of the inner layers can be relatively thin, as compared to the other outer layers. For example, in some embodiments wherein the multiple layer interlayer is a three-layer interlayer, the innermost layer can have a thickness of not more than about 12, not more than about 10, not more than about 9, not more than about 8, not more than about 7, not more than about 6, not more than about 5 mils, or it may have a thickness in the range of from about 2 to about 12 mils, about 3 to about 10 mils, or about 4 to about 9 mils. In the same or other embodiments, the thickness of each of the outer layers can be at least about 4, at least about 5, at least about 6, at least about 7 mils and/or not more than about 15, not more than about 13, not more than about 12, not more than about 10, not more than about 9, not more than about 8 mils, or can be in the range of from about 2 to about 15, about 3 to about 13, or about 4 to about 10 mils. When the interlayer includes two outer layers, these layers can have a combined thickness of at least about 9, at least about 13, at least about 15, at least about 16, at least about 18, at least about 20, at least about 23, at least about 25, at least about 26, at least about 28, or at least about 30 mils, and/or not more than about 73, not more than about 60, not more than about 50, not more than about 45, not more than about 40, not more than about 35 mils, or in the range of from about 9 to about 70 mils, about 13 to about 40 mils, or about 25 to about 35 mils.

According to some embodiments, the ratio of the thickness of one of the outer layers to one of the inner layers in a multiple layer interlayer can be at least about 1.4:1, at least about 1.5:1, at least about 1.8:1, at least about 2:1, at least about 2.5:1, at least about 2.75:1, at least about 3:1, at least about 3.25:1, at least about 3.5:1, at least about 3.75:1, or at least about 4:1. When the interlayer is a three-layer interlayer having an inner core layer disposed between a pair of outer skin layers, the ratio of the thickness of one of the skin layers to the thickness of the core layer may fall within one or more of the ranges above. In some embodiments, the ratio of the combined thickness of the outer layers to the inner layer can be at least about 2.25:1, at least about 2.4:1, at least about 2.5:1, at least about 2.8:1, at least about 3:1, at least about 3.5:1, at least about 4:1, at least about 4.5:1, at least about 5:1, at least about 5.5:1, at least about 6:1, at least about 6.5:1, or at least about 7:1 and/or not more than about 30:1, not more than about 20:1, not more than about 15:1, not more than about 10:1, not more than about 9:1, or not more than about 8:1.

Multiple layer interlayers as described herein can comprise generally flat interlayers having substantially the same thickness along the length, or longest dimension, and/or width, or second longest dimension, of the sheet. In some embodiments, however, the multiple layer interlayers of the present invention can be tapered, or wedge-shaped, interlayers that comprise at least one tapered zone having a wedge-shaped profile. Tapered interlayers have a changing thickness profile along at least a portion of the length and/or width of the sheet, such that, for example, at least one edge of the interlayer has a thickness greater than the other. When the interlayer is a tapered interlayer, at least 1, at least 2, at least 3, or more of the individual resin layers may include at least one tapered zone. Tapered interlayers may be particularly useful in, for example, heads-up display (HUD) panels in automotive and aircraft applications.

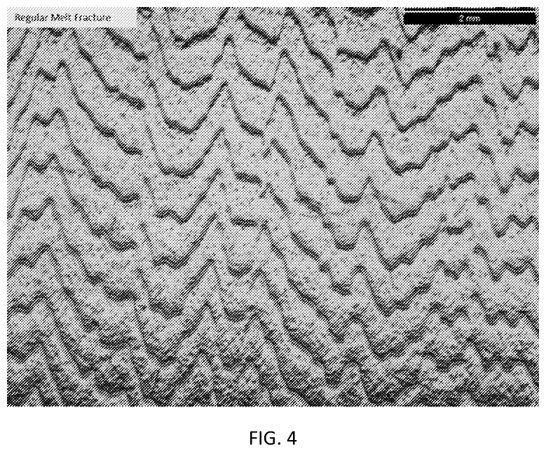

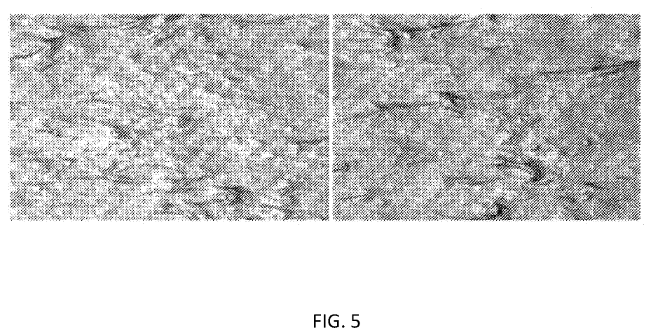

In certain embodiments, a surface roughness may be created on one or more layers of the interlayer. Generally, such surface roughness may be imparted via melt fracture or via embossing. Melt fracture is a process of forming a roughness on the surface of a polymer interlayer layer through control of the composition of the melts, the temperature of the die lips, and/or through control of the rate and method of cooling of the extruded interlayer, which can be, for example, immersed in a cooling bath soon after extrusion. (See, for example, U.S. Pat. Nos. 5,595,818 and 4,654,179, the entire disclosures of which are incorporated by reference herein). In some embodiments, it may be preferred for one or more layers of the interlayer to be formed with a “regular melt fracture pattern.” As used herein, the term “regular melt fracture pattern” or “regular pattern” is used to mean a pattern that is generally repeated or repeatable. Examples of regular patterns include, but are not limited to, parallel channels, sawtooth patterns, geometric shapes such as squares, pyramids, and the like, or combinations of patterns. FIG. 4 illustrates a regular melt fracture pattern formed on a polymer layer, which is referred to as a “tire track” pattern. In contrast, a random pattern refers to a pattern that has no regular or repeating pattern throughout the surface. FIG. 5 illustrates a random pattern formed on a polymer layer.

In the case of three individual layers that are laminated together to form the trilayer interlayer, any of the surfaces of the three layers can be formed with regular pattern surface roughness through melt fracture prior to, or during, assembly of the layers. In various embodiments, one or both of the two surfaces of the individual polymer layers that will form the outer skin layers 16 of the trilayer interlayer may be formed with regular pattern surface roughness through melt fracture.

According to embodiments of the present invention, one or both surfaces of the outer, skin polymer layers are modified using controlled melt fracture to produce a polymer layer having the desired regular pattern surface roughness, as perhaps measured by “R_{z}” or “Rₛₘ” values. R_{z} is a measure of the surface topography of a polymer layer and is an indication of divergence of the surface from a plane (e.g., an imaginary plane presented by a flattened surface of the polymer layer). Rₛₘ is a measure of the distance between peaks in the topography of the surface of a polymer layer. Both measurements will be described in detail, below. As used herein, with regard to R_{z} and Rₛₘ, “imparted by melt fracture” means that surface texture measured by R_{z} and Rₛₘ is produced through the melt fracture phenomenon at the time of extrusion.

For a typical surface pattern, the surface roughness, or the height of particular peaks on the roughened surface from the imaginary plane of the surface of the flattened polymer layer, is the R_{z} value of the surface. The surface roughness, or R_{z}, of the surface of a polymer interlayer sheet when described in this application will be expressed in microns (μm) as measured by a 10-point average roughness in accordance with DIN ES ISO-4287 of the International Organization for Standardization and ASME B46.1 of the American Society of Mechanical Engineers. In general, under these scales, R_{z} is calculated as the arithmetic mean value of the single roughness depths R_{zi} (i.e., the vertical distance between the highest peak and the deepest valley within a sampling length) of consecutive sampling lengths:

$$Rz = \frac{1}{N} \times ( Rz 1 + {R}_{z 2} + … + {R}_{z N )}$$

Another surface parameter described and measured is the mean spacing Rₛₘ. The mean spacing, Rₛₘ, describes the average width, expressed in microns (μm), between peaks on the surface of the polymer interlayer sheet. In general, Rₛₘ and R_{z} values can be utilized to measure the surface typography of both embossed and non-embossed polymer interlayer sheets. However, in general, the surface roughness described herein as being imparted onto the surfaces of the polymer layers is imparted by non-embossing processes, such as by melt fracture.

The resulting interlayer, with the individual polymer layers having the specified R_{z} and/or Rₛₘ, can be readily laminated between two glazing layers such as glass. The R_{z} and Rₛₘ values given above, which are created by melt fracture and which are present on at least one, and preferably both surfaces of the outer layers of a three layer interlayer, result in outer surfaces that can be readily deaired after they are placed in contact with glass layers and laminated, for example using a nip roll or vacuum ring deairing process.

However, as was described above, glass panels that include multilayer interlayers can include objectionable visual defects and/or optical distortion in the final unitary structure. Such defects/distortions may be referred to as mottle, which is a measure of the graininess or texture of the surface area of the polymer interlayers. It is believed that mottle is caused by small scale surface variations of the interfaces between layers of the laminate having different refractive indices.

Traditionally, assessments of the degree or amount of mottle in a multilayer glass panel were determined using a shadowgraph-based technique. A shadowgraph is an optical method that reveals non-uniformities in transparent media like air, water, or glass. In principle, the unaided human eye cannot directly see differences or disturbances in transparent air, water or glass. However, all these disturbances/differences refract light rays and, accordingly, they can cast shadows. A shadowgraph exploits this property of the ability of the disturbances or differences in a laminate to cast shadows and utilizes it to project an image of the non-uniformities in the laminate onto a screen.

In the traditional process for ascertaining mottle, the severity of the mottle was assessed and categorized by a side-to-side qualitative comparison of the shadowgraph projections for the multilayer test laminate with a set of standard laminate shadowgraphs representing a series or scale of mottle values ranging from 0 to 4 (e.g., CMS 2.5 standard laminate with a scale of 0 to 4), with 0 representing no mottle (e.g., a piece of glass with no interlayer), 1 representing a standard of low mottle (i.e., a low number of disruptions) and 4 representing a standard of high mottle (i.e., a high number of disruptions), which is optically objectionable. In some embodiments, the qualitative comparisons can be performed by the human eye or via computer-implemented testing. For instance, a mottle analyzer device may be used, in which a camera is located generally perpendicular to the reflective screen upon which a shadowgraph is depicted. The camera can capture images of the shadowgraph(s), and a computing device can perform the necessary comparisons to obtain mottle values for the samples being tested.

For example, the mottle values provided herein were determined using a Clear Mottle Analyzer (CMA) that includes a xenon arc lamp, a sample holder, a projection screen, and a digital camera. The xenon arc lamp is used to project a shadowgraph of a laminated sample onto the screen and the camera is configured to capture an image of the resulting shadowgraph. The image is then digitally analyzed using computer imaging software and compared to images of previously-captured standard samples to determine the mottle of the sample. A method of measuring mottle using a CMA is described in detail in U.S. Pat. No. 9,311,699, which is incorporated by reference herein in its entirety.

As was also disclosed above, optical defects known as iceflowers are commonly found in glass panel laminates that include multilayer interlayers. The formation of iceflowers in trilayer acoustic PVB laminates can be tested by simulating the real world situation in windshields and other glazings where the combination of large bending gaps and poor deairing are known to be among the root causes for iceflower development in the field. The following steps describe an iceflower test, which can be used to measure the formation of iceflowers in an interlayer. First, a 30 cm by 30 cm trilayer interlayer with a polyethylene terephthalate (PET) film ring (with an inside diameter of 7.5 cm;

an outside diameter of 14 cm; and a thickness of 0.10 mm to 0.18 mm) placed in the center is sandwiched between two 30 cm by 30 cm pieces of glass. The construct is then pre-laminated and autoclaved. The resulting laminates are allowed to condition at room temperature for 48 hours, baked in a conventional oven (at 80° C.) for 48 hours, and then allowed to cool. The laminates may then be visually inspected to determine the rate of iceflower formation in the laminate (e.g., the percentage of laminates that developed iceflower defects) and the percentage of area within the PET ring with iceflower defects. Additionally, the laminates may be visually inspected to determine the percentage of iceflower formation within the entire laminate (including both inside and outside the PET film area).

In view of the above, embodiments of the present invention include a polymer interlayer that has reduced mottle and resists formation of iceflower defects. The polymer interlayer may comprise a first polymer layer (e.g., a core layer) and a second polymer layer (e.g., a skin layer), with the first polymer layer being disposed on a first side of the second polymer layer. A non-embossed surface of the first side of the second polymer layer includes a surface roughness, defined by an R_{z} value, of greater than 40 microns. In addition, the polymer interlayer has a mottle value of less than 1.0. In some embodiments, a second side (opposite the first side) of the second polymer layer may also include a surface roughness, defined by an R_{z} value, of greater than 40 microns. Such second side of the second polymer layer may form an exterior surface of the polymer interlayer. In some embodiments, the polymer interlayer may be an interlayer having a third polymer layer (e.g., a skin layer) disposed on a second side of the first polymer layer, such that the second and third polymer layers sandwich the first polymer layer. In some embodiments, first and/or second sides of the third polymer layer may also include a surface roughness, defined by an R_{z} value, of greater than 40 microns. The first side of the third polymer layer may be in contact with the first polymer layer, while the second side (opposite the first side) of the third polymer layer may form an exterior surface of the interlayer. Such above-described surface roughness of the second and third polymer layers may have a regular pattern that is formed by melt fracture.

In some embodiments, the surface roughness of the first and/or second surfaces of the second polymer layer (i.e., one of the skin layers) is formed by melt fracture. In some embodiments, the surface roughness, as defined by the R_{z} value, will be greater than 40, 50, 60, or 70 microns, and/or the R_{z} value will be between 40 and 70, 40 and 60, 40 and 50, 50 and 70, 50 and 60, or between 60 and 70 microns. In some embodiments, each of the surfaces of the first and second sides of the second and third polymer layers (i.e., the skin layers) may be formed with the surface roughness discussed above. In addition to such surface roughness, the interlayer may, in some embodiments, have a mottle value less than 0.9, 0.8, 0.7, 0.6, or 0.5, and/or the mottle value may be from 0.0 to 1.0, 0.25 to 1.0, 0.5 to 1.0, 0.5 to 0.9, 0.5 to 0.8. Furthermore, when the polymer interlayer is laminated between a pair of glass panels to form a multiple layer panel, the multiple layer panel may have essentially no iceflower formation.

In addition, or in conjunction, the polymer interlayer may comprise a first polymer layer (e.g., a core layer) and a second polymer layer (e.g., a skin layer), with the first polymer layer being disposed on a first side of the second polymer layer. A non-embossed surface of the first side of the second polymer layer includes a surface roughness, defined by an Rₛₘ value, of greater than 500 microns. In addition, the polymer interlayer has a mottle value of less than 1.0. In some embodiments, the first side of the second polymer layer may be in contact with the first polymer layer. In addition, a second side (opposite the first side) of the second polymer layer may also include a surface roughness, defined by an Rₛₘ value, of greater than 500 microns. Such second side of the second polymer layer may form an exterior surface of the interlayer. In some embodiments, the polymer interlayer may be an interlayer having a third polymer layer (e.g., a skin layer) disposed on a second side of the first polymer layer, such that the second and third polymer layers sandwich the second polymer layer. In some embodiments, first and/or second sides of the third polymer layer may also include a surface roughness, defined by an Rₛₘ value, of greater than 500 microns. The first side of the third polymer layer may be in contact with the first polymer layer, while the second side (opposite the first side) of the third polymer layer may form an exterior surface of the interlayer. Such above-described surface roughness of the second and third polymer layers may have a regular pattern that is formed by melt fracture.

In some embodiments, the surface roughness of the surface of the first side of the second polymer layer (i.e., the skin layer) is formed by a non-embossed process, such as by melt fracture. In some embodiments, the surface roughness, as defined by the Rₛₘ value, will be greater than 400, 500, 600, 700, or 800 microns, and/or the Rₛₘ value is between 400 and 800, 500 and 800, 400 and 700, 500 and 700, 400 and 600, 500 and 600, 600 and 700, 600 and 700, or 700 and 800 microns. In some embodiments, each of the surfaces of the first and second sides of the second and third polymer layers (i.e., the skin layers) may be formed with the surface roughness discussed above. In addition to such surface roughness, the interlayer may, in some embodiments, have a mottle value is less than 0.9, 0.8, 0.7, 0.6, or 0.5, and/or wherein the mottle value is from 0.0 to 1.0, 0.25 to 1.0, 0.5 to 1.0, 0.5 to 0.9, or 0.5 to 0.8. Furthermore, when the polymer interlayer is laminated between a pair of glass panels to form a multiple layer panel, the multiple layer panel may have essentially no iceflower formation.

The above-described polymer interlayers may be formed by controlling temperature attributes of a co-extrusion process. For instance, embodiments of the present invention include a method of forming a polymer interlayer that resists formation of optical defects. The method comprises the step of extruding a first polymer layer (e.g., a core layer) through a co-extrusion die. An additional step includes extruding a second polymer layer (e.g., a skin layer) through the co-extrusion die. During the extruding of the second polymer layer, the second polymer layer contacts a die lip of the co-extrusion die. A further step includes extruding a third polymer layer (e.g., another skin layer) through the co-extrusion die. Upon the extruding steps, the first polymer layer is positioned between the second and third polymer layers and is disposed on a first side of the second polymer layer. During the extruding of the second polymer layer, a surface of the first side of the second polymer layer is formed with a surface roughness by melt fracture. During the extruding steps, a temperature of the die lip is at least 10° C. greater than a temperature of the first polymer. Furthermore, upon the extruding steps, the polymer interlayer has a mottle value of less than 1.0.

The above process may also be described as the melt stream forming the first polymer layer (e.g., the core layer) being extruded through the co-extruder with a temperature that is different than the melt streams forming the second and/or third polymer layers (e.g., the skin layers). As such, during the extruding of the polymer layers, the surface of the first side of the second polymer layer is formed with a surface roughness by melt fracture (e.g., with the R_{z} and/or Rₛₘ values discussed above). In particular, such melt fracture may be controlled by controlling the temperatures of the die lip that is in contact with the melt stream that forms the second polymer layer. As such, the temperature difference between the first polymer layer (i.e., the core layer which does not contact the die lip) and the second polymer layer (i.e., the skin layer that does contact the die lip) can be controlled during extrusion. For instance, in some embodiments, the requisite surface roughness of the surface of the first side of the second polymer layer (i.e., the skin layer) (e.g., R_{z} greater than 40 microns and/or Rₛₘ greater than 500 microns) necessary for beneficial reduction in iceflower formation can be achieved, while maintaining low mottle for the interlayer, by ensuring that a temperature of the die lip is at least 10° C. greater than a temperature of the melt stream used to form the first polymer layer (i.e., the core layer) as the polymer layers exit the die. The second surface of the second polymer layer may also be formed with a surface roughness through melt facture, in a manner similar to that discussed above (i.e., by controlling the temperature of the die lips of the co-extruder). Regardless, upon extruding the first and second polymer layers, embodiments of the present invention provide for the polymer interlayer to have a mottle value of less than 1.0. Furthermore, when the polymer interlayer is laminated between a pair of glass panels to form a multiple layer panel, the multiple layer panel may have essentially no iceflower formation.

In some embodiments, first and/or second sides the third polymer layer (i.e., the remaining skin layer of the interlayer) may also be formed with regular pattern surface roughness formed by melt fracture. Such melt fracture on the surface(s) of the third polymer layer may be controlled by controlling the temperature of the die lip that is in contact with the melt stream that forms the third polymer layer, in a manner similar to that discussed above.

For example, the temperature of one or both of the die lips may be at least 10° C., 20° C., 30° C., 40° C., or 50° C. greater than the temperature of the first melt stream and/or of the first polymer layer (i.e., the core layer) during the extrusion process. In addition, or in conjunction, a temperature of one or both of the die lips may be greater than 160° C. during the extrusion of the second and/or third polymer layers (i.e., the skin layers). In some embodiments, the temperature of one or both of the die lips is greater than 170° C., 180° C., 190° C., 200° C., or 210° C. during the extrusion of the second and/or third polymer layers, and/or the temperature of one or both of the die lips is between 160° C. and 210° C., 160° and 200° C., 170° C. and 200° C., 180° and 200° C., 190° C. and 210° C., or 200° C. and 210° C. during the extrusion of the second and/or third polymer layers. A temperature of the first melt stream, which is used to form the first polymer layer (i.e., the core layer), may be between 140° C. to 170° C. during extrusion of the first polymer layer (e.g., the core layer).

During extrusion of the inventive interlayer, the regular pattern surface roughness formed on the surfaces of the second and third polymer layers (i.e., on the skin layers) may be controlled by controlling the temperature of the die lips, whereas the mottle of the resulting interlayer may be controlled by controlling the temperature difference of the die lips and the temperature of the first melt stream, which is used to form the first polymer layer (i.e., the core layer). Control of such temperature differences may enhance rheological similarities between the skin layers and the core layer so as to improve mottle characteristics of the interlayer. For example, during the extrusion of the interlayer, the temperature difference between one or both of the die lips and the temperature of the first melt stream may be at least 10° C., 20° C., 30° C., 40° C., or 50°° C. and/or no more than 50°° C., 40° C., 30° C., 20° C., 10° C., or 5° C. Similarly, in some embodiments, during the extrusion of interlayer, the temperature difference between one or both of the die lips and the temperature of the first melt stream may be between 5° C. and 50° C., 10° C. and 50° C., 10° C. and 40° C., 10° C. and 30° C., 10° C. and 20° C., 20° C. and 50° C., 20° C. and 40° C., 20° C. and 30° C., 30° C. and 50° C., 30° C. and 40° C., or 40° C. and 50° C.

The preferred mottle value of the interlayer discussed above (e.g., less than 1.0) may be associated with a particular Delta G′ value and/or Delta G′ range in relation to one of the skin layers (e.g., the second or third polymer layers) and the core layer (e.g., the first polymer layer). Delta G′ is the difference between the storage modulus values of two layers. Storage modulus is a measure of resistance of the material to deformation, and is generally provided in units of pascals (Pa). The storage modulus of each of the layers of the interlayer described herein can be measured according to ASTM D-4065. For example, the storage modulus values can be obtained using a Dynamic Mechanical Thermal Analysis (DMTA) such as by using a TA DHR-2 rheology instrument. Samples of polymer layers can be clamped and placed in tension within a testing cell. The temperature of the testing cell can be initially set to 75° C. A sinusoidal tensile strain can be applied to the samples at a given frequency over a range of temperatures and the resulting stress responses are measured. For example, the sinusoidal tensile strain can be applied to the samples at 1 Hz, while temperature of the samples can be shifted from 20° C. to 200° C. The ramp rate of the temperature can be about 3° C. per minute, and data (i.e., stress of the samples) can be collected every 10 seconds. The storage modulus can be obtained from the ratio of stress to strain, with it being understood that the storage modulus value for a given sample will generally vary with the temperature applied to the sample. For an oscillatory tensile deformation, the storage modulus is the real part of the complex modulus. Upon obtaining storage modulus values for one of the skin layers and for the core layer, the difference between such storage values can be calculated to obtain the Delta G′ value.

Embodiments of the present invention include a polymer interlayer and/or a method of making a polymer interlayer that resists formation of optical defects, with such polymer interlayer having polymer layers with preferred Delta G′ values. For example, embodiments of the present invention may include a polymer interlayer formed according to the following method. One step includes extruding a first polymer layer (e.g., a core layer) through a co-extrusion die. An additional step includes extruding a second polymer layer (e.g., a skin layer) through the co-extrusion die. A further step includes extruding a third polymer layer (e.g., a skin layer) through the co-extrusion die. Upon the extruding steps, the first polymer layer is positioned between the second and third polymer layers. During the extruding of the first polymer layer, the first polymer layer has a first storage modulus value. During the extruding of the second polymer layer, the second polymer layer has a second storage modulus value. A difference between the first storage modulus value and the second storage modulus value (i.e., the Delta G′ value) may be less than about 45,000 Pa. Upon the extruding steps, the polymer interlayer has a mottle value of less than 1.0.

Embodiments of the present invention may provide for the interlayer to have a Delta G′ value, as measured during co-extrusion of the interlayer through a co-extrusion device, between one of the skin layers (e.g., the second or third polymer layers) and the core layer (e.g., the first polymer layer) of less than 60,000 Pa, less than 55,000 Pa, less than 50,000 Pa, less than 45,000 Pa, less than 40,000 Pa, less than 35,000 Pa, less than 30,000 Pa, less than 25,000 Pa, less than 20,000 Pa, less than 15,000 Pa, less than 10,000 Pa, or less than 5,000 Pa. In some embodiments, the Delta G′ value between one of the skin layers and the core layer may be between 5,000 and 60,000 Pa, between 5,000 and 50,000 Pa, between 5,000 and 40,000 Pa, between 5,000 and 30,000 Pa, between 10,000 and 50,000 Pa, between 10,000 and 40,000 Pa, between 10,000 and 30,000 Pa, between 15,000 and 50,000 Pa, between 15,000 and 40,000 Pa, between 15,000 and 30,000 Pa, between 20,000 and 50,000 Pa, between 20,000 and 40,000 Pa, or between 20,000 and 30,000 Pa.

### EXAMPLE 1

Two trilayer interlayers were formed, with each of the interlayers comprising a core layer sandwiched between a pair of skin layers. The skin layers were formed with regular melt fracture patterns by controlling the lip temperatures of the lips of the die used to form the skin layers. The skin layers were formed from a PVB resin having a unimodal molecular weight distribution and a polydispersity index less than 3.0. The skin layer resin included 38 phr of plasticizer, as well as adhesion control agents and UV stabilizer as needed. The core layer resin comprised PVB and included 75 phr of plasticizer, as well as adhesion control agents and UV stabilizer as needed. The interlayers were formed via a co-extrusion process. The hot die lip gap during extrusion, with die lip bolt operating at 30% power, was set at 41 mils (1.04 mm). The extrusion rate was set at 550 lb/hr (250 kg/hr). The melt pipe, the EAMF filter, the die lips for the skin layers, and body temperature were set at 204° C. The core melt temperature for the core layer was set at between 170° C. and 180° C.

A first of the trilayer interlayers, EX1-IIL1, was formed with a surface roughness lower than a second of the trilayer interlayers, EX2-IIL2. The surface roughness measurements for both exterior sides of each of EX1-IIL1 and EX1-IIL2 (i.e., both exterior surfaces of the relevant skin layers) are provided below in Table 1. MD refers to surface roughness in the machine direction, while CMD refers to surface roughness in the cross-machine direction. The mottle for each trilayer interlayer was also measured.

TABLE 1

| | First Side | | | | Second Side | | | | |
|---|---|---|---|---|---|---|---|---|---|
| | Rz | Rsm | Rz | Rsm | Rz | Rsm | Rz | Rsm | |
| | MD | MD | CMD | CMD | MD | MD | CMD | CMD | Mottle |
| EX1- | 52.0 | 629.7 | 55.7 | 534.7 | 47.7 | 673.6 | 49.6 | 446.5 | <1.0 |
| IIL1 | | | | | | | | | |
| EX1- | 63.7 | 825.6 | 60.4 | 516.4 | 58.3 | 709.1 | 61.0 | 403.1 | >1.0 |
| IIL2 | | | | | | | | | |

As illustrated by the data from Example 1, preferred mottle values (e.g., mottle values less than 1.0) were obtained by controlling the regular pattern surface roughness of the skin layers imparted by melt fracture. In particular, a trilayer interlayer with skin layers having surface roughness values, R_{z}, between 40 and 60 microns and/or Rₛₘ between 400 and 700 microns, e.g., EX1-IIL1, provides for the trilayer interlayer to have a preferred mottle value of less than 1.0. In contrast, a trilayer interlayer with skin layers having surface roughness values, R_{z}, greater than 60 microns and/or Rₛₘ greater than 800 microns showed such interlayer to have a non-preferred mottle value of greater than 1.0.

### EXAMPLE 2

Two inventive trilayer interlayers (Example 2 Inventive Interlayers: EX2-IIL1 and EX2-IIL2) were formed according to the same process described above for EX1-IIL1 and EX1-IIL2 in Example 1. As such, each inventive interlayer, EX2-IIL1 and EX2-IIL2, included a core layer sandwiched between a pair of skin layers, with the skin layers formed with regular melt fracture patterns by controlling the lip temperatures of the lips of the die used to form the skin layers. The resulting inventive trilayer interlayers EX2-IIL1 and EX2-IIL2 included surface roughness values R_{z} of between 40 and 60 microns and Rₛₘ between 400 and 700 microns, as well as a mottle value of less than 1.0.

Two control trilayer interlayers (Example 2 Control Interlayers: EX2-CIL1 and EX2-CIL2) were formed using a standard, prior art process that used embossing to form surface roughness on the skin layers. In contrast to the inventive interlayer, the surface of the skin layers of the control interlayers were not formed by melt fracture. Instead, the control interlayers included surface patterns on the skin layers formed by embossing.

Table 2, shown below, illustrates measured mottle values for each of EX2-IIL1, EX2-IIL2, EX2-CIL1 and EX2-CIL2. Such mottle values were measured upon formation of the interlayers (e.g., time zero), as well as thirty-five days after the interlayers were formed. Table 2 also illustrates the average mottle values of the inventive and control interlayers.

TABLE 2

| | Time zero | 35 days |
|---|---|---|
| EX2-IIL1 | 0.63 | 0.83 |
| EX2-IIL2 | 0.53 | 0.78 |
| Average | 0.58 | 0.81 |
| EX2-CIL1 | 0.73 | 1.17 |
| EX2-CIL2 | 0.83 | 1.14 |
| Average | 0.78 | 1.16 |

As illustrated by the data from Example 2, excellent and highly desirable mottle values (e.g., mottle values less than 1.0) can be obtained by controlling the regular pattern surface roughness of the skin layers imparted by melt fracture. Such mottle values were optimally maintained below 1.0 for each of the inventive interlayers EX2-IIL1 and EX2-IIL2 upon formation and thirty-five days after formation. In contrast, although the control interlayers EX2-CIL1 and EX2-CIL2 (which included surface roughness formed by embossing) included a mottle value below 1.0 upon formation, the control interlayers had a non-preferred mottle value of greater than 1.0 after thirty-five days.

### EXAMPLE 3

Ten inventive trilayer interlayers (Example 3 Inventive Interlayers: EX3-IIL1, EX3-IIL2, . . . , EX3-IIL10) were formed according to the same process described above for EX1-IIL1 and EX1-IIL2 in Example 1. As such, each inventive interlayer, EX3-IIL1 to EX3-IIL10, included a core layer sandwiched between a pair of skin layers, with the skin layers being formed with regular melt fracture patterns by controlling the lip temperatures of the lips of the die used to form the skin layers. The resulting inventive trilayer interlayers EX3-IIL1 to EX3-IIL10 included surface roughness values R_{z} of between 40 and 60 microns and Rₛₘ values between 400 and 700 microns, as well as a mottle value of less than 1.0.

In addition, ten control trilayer interlayers (Example 3 Control Interlayers: EX3-CIL1, EX3-CIL2, . . . , EX3-CIL10) were formed using a standard, prior art process that used embossing to form surface roughness on the skin layers. In contrast to the inventive interlayer, the surfaces of the skin layers of the control interlayers were not formed by melt fracture. Instead, the control interlayers included surface patterns on the skin layers formed by embossing.

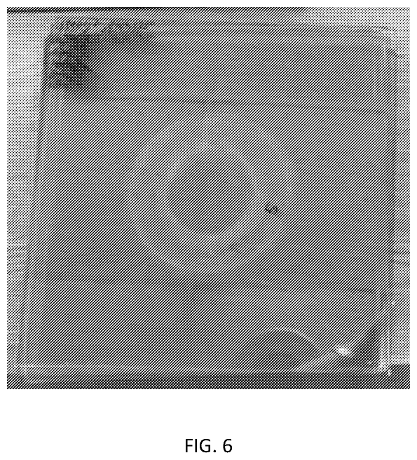

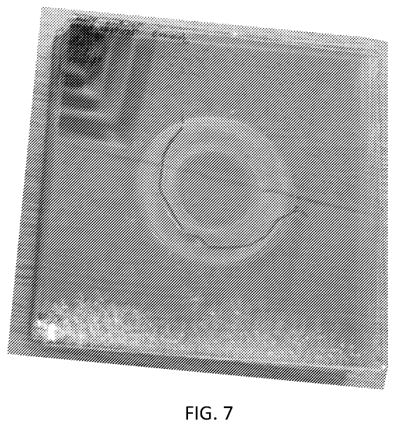

Each of the inventive trilayer interlayers and the control interlayers were tested according the iceflower test described above. Notably, none of the laminates formed with the inventive trilayer interlayers (EX3-IIL1, EX3-IIL2, . . . , EX3-IIL10) showed any iceflower formation. Specifically, FIG. 6 is a photograph of a stack of laminates that each comprises one of the inventive trilayer interlayers (EX3-IIL1, EX3-IIL2, . . . , EX3-IIL10) laminated between a pair of glass sheets. As illustrated, none of such laminates shows any iceflower formation. In contrast, each of the laminates formed with the control trilayer interlayers (EX3-CIL1, EX3-CIL2, . . . , EX3-CIL10) were found to include varying degrees of iceflower formation, as illustrated in FIG. 7, which is a photograph of a stack of laminates formed with the control trilayer interlayers. Specifically, as illustrated in FIG. 7, lower portions of the laminates formed with the control trilayer interlayers were found to include iceflower formation.

### EXAMPLE 4

Two inventive trilayer interlayers (Example 4 Inventive Interlayers: EX4-IIL1 and EX4-IIL2) were formed according to the same process described above for EX1-IIL1 and EX1-IIL2 in Example 1. As such, each inventive interlayer, EX4-IIL1 and EX4-IIL2, included a core layer sandwiched between a pair of skin layers, with the skin layers being formed with regular melt fracture patterns by controlling the lip temperatures of the lips of the die used to form the skin layers. The resulting inventive trilayer interlayers EX4-IIL1 and EX4-IIL2 included surface roughness values R_{z} of between 40 and 60 microns and/or Rₛₘ between 400 and 700 microns, as well as a mottle value of less than 1.0.

Two embossed control trilayer interlayers (Example 4 Control Interlayers: EX4-CIL1 and EX4-CIL2) were formed using a standard, prior art process that used embossing to form surface roughness on the skin layers. In contrast to the inventive interlayer, the surfaces of the skin layers of the control interlayers were not formed by melt fracture. Instead, the control interlayers included surface patterns on the skin layers formed by embossing.

Furthermore, two random melt fracture control trilayer interlayers (Example 4 Control Interlayers: EX4-RIL1 and EX4-RIL2) were formed using a prior art process. In contrast to the inventive interlayer, the surfaces of the skin layers of the control interlayers were not formed with a regular pattern surface roughness by melt fracture. Instead, the random control interlayers included random surface patterns on the skin layers formed by melt fracture.

Each of the interlayer samples was tested for light transmission after vacuum bag deairing. Vacuum bag deairing is a technique that is used to evacuate air from a sample prior to the final step of autoclaving. It frequently can be employed to improve autoclave yields in commercial operations. Each of the interlayer samples was placed between two panes of glass and laminated to form a laminated panel. It is noted that one of each of the samples was laminated with flat, non-shaped glass panels (referred to in Table 3 as “Not Shaped”), while the other of each of the samples was laminated with shaped (e.g., curved) glass panels (referred to in Table 3 as “Shaped”). The laminated panels were then placed in a resilient rubber bag, which was then evacuated by a vacuum hose mated to the bag. The bag was brought up to and held at a temperature of about 50° C. for 60 minutes and then to 120° C. for 20 minutes while under vacuum. The bag was then cooled, and the resulting panels were removed and placed in an autoclave for final finishing.

Light transmission measurements, as a percentage, were taken after vacuum bag deairing and before autoclaving. A low light transmission percentage value is indicative of inadequate deairing, whereas a high light transmission percentage value is indicative of acceptable deairing. Light transmission was tested with a spectrophotometer. Each laminate was tested eight times at dispersed locations throughout the laminate, and the eight results were averaged to give light transmission values, as shown in Table 3, where LT is light transmission.

TABLE 3

| | Treatment | | | | | |
|---|---|---|---|---|---|---|
| | Not Shaped | | | Shaped | | |
| | Sample | | | | | |
| | EX4- | EX4- | EX4- | EX4- | EX4- | EX4- |
| | IIL1 | RIL1 | CIL1 | IIL2 | RIL2 | CIL2 |
| Average LT | 85% | 70-75% | 98-100% | 81% | 60-70 | 90-98% |

As can be seen from Table 3 above, the two embossed control trilayer interlayers EX4-CIL1 and EX4-CIL2 showed the best light transmission characteristics (highest light transmission percentage, which was indicative of better or acceptable deairing), whereas the two random control trilayer interlayers EX4-RIL1 and EX4-RIL2 showed the lowest or worst light transmission characteristics (lowest light transmission percentage, which was indicative of unacceptable deairing). The two inventive trilayer interlayers EX4-IIL1 and EX2-IIL4 showed improved light transmission characteristics over the two random control trilayer interlayers EX4-RIL1 and EX4-RIL2 (i.e., an improved or higher light transmission percentage, which was indicative of acceptable deairing). As such, the present example shows that the inventive trilayer interlayers can be adequately deaired via standard, vacuum bag deairing processes, whereas the random trilayer interlayers formed with random melt fracture patterns cannot be adequately deaired via such standard, vacuum bag deairing processes. Specifically, the random trilayer interlayers must also be embossed (as with the control trilayer interlayers) in order to be adequately deaired, whereas the inventive trilayer interlayers do not need to be further embossed for adequate deairing.

### EXAMPLE 5

Four polymer layers were formed (Example 5 Polymer Layers: EX5-PL1, EX5-PL2, EX5-PL3, and EX5-PL4). The Example 5 Polymer Layers were then tested according to ASTM D-4065, as discussed below, to determine storage modulus values for the polymer layers at various temperatures. Upon determining such storage modulus values, Delta G′ values were calculated to compare EX5-PL4 to each of EX5-PL1, EX5-PL2, and EX5-PL3.

For the EX5-PL1, EX5-PL2, and EX5-PL3 polymer layers, such polymer layers were formed by mixing a PVB resin and 38 phr of plasticizer. The resin of the EX5-PL1 polymer layer had a molecular weight of 150K Daltons, whereas the resins of the EX5-PL2 and the EX5-PL3 polymer layers had a molecular weight of 160K Daltons.

For the EX5-PL4 polymer layer, the polymer layer comprised PVB and 75 phr of plasticizer. The resin of the EX5-PL4 polymer layer had a molecular weight of between 250 and 300 K Daltons. Given the compositions of the Example 5 Polymer Layers described above, EX5-PL4 generally corresponded with a core layer of an acoustic trilayer interlayer, while EX5-PL1, EX5-PL2, and EX5-PL3 generally corresponded with skin layers of an acoustic trilayer interlayer.

Storage modulus values were obtained for each of the Example 5 Polymer Layers using a Dynamic Mechanical Thermal Analysis (DMTA), as previously described. The storage modulus values for the polymer layers were then obtained at the various temperatures indicated below in Table 4. For the EX5-PL1 and EX5-PL2 polymer layers, storage modulus values were obtained for temperatures from 140° C. to 200° C. in ten degree intervals. For the EX5-PL3 polymer layer, a storage modulus value was obtained for a temperature of 200° C. For the EX5-PL4 polymer layer, storage modulus values were obtained for temperatures from 170° C. and 180° C.

Upon obtaining the storage modulus values for the Example 5 Polymer Layers, the difference between such storage modulus values were calculated for EX5-PL4 compared to each of EX5-PL1, EX5-PL2, and EX5-PL3 to obtain Delta G′ values for such samples (at the indicated temperatures). The resulting Delta G′ values are provided below in Table 4. It is noted that the Delta G′ values were obtained by respectively subtracting the storage modulus values of EX5-PL1, EX5-PL2, and/or EX5-PL3 from the storage modulus values of EX5-PL4. Thus, positive Delta G′ values were indicative of the EX5-PL4 polymer layer (i.e., the core layer) being relatively softer than EX5-PL1, EX5-PL2, and/or EX5-PL3 polymer layers (i.e., the skin layers). In contrast, negative Delta G′ values are indicative of the EX5-PL4 polymer layer being relatively stiffer than the EX5-PL1, EX5-PL2, and/or EX5-PL3 polymer layers.

TABLE 4

| Mottle | | ≤1.0 | ≤1.0 | ≤1.0 | ≤1.0 | ≤1.0 | >1.0 | >1.0 |
|---|---|---|---|---|---|---|---|---|
| EX5-PL1 | Temp (° C.) | 200 | 190 | 180 | 170 | 160 | 150 | 140 |
| EX5-PL4 at | Delta G′ (Pa) | −8.68E+03 | −4.57E+03 | 2.56E+03 | 1.40E+04 | 2.96E+04 | 5.04E+04 | 7.58E+04 |
| 180° C. | | | | | | | | |
| EX5-PL4 at | Delta G′ (Pa) | −8.64E+03 | −4.52E+03 | 2.61E+03 | 1.40E+04 | 2.97E+04 | 5.05E+04 | 7.59E+04 |
| 170° C. | | | | | | | | |

| Mottle | | ≤1.0 | ≤1.0 | ≤1.0 | ≤1.0 | ≤1.0 | >1.0 | >1.0 |
|---|---|---|---|---|---|---|---|---|
| EX5-PL2 | Temp (° C.) | 200 | 190 | 180 | 170 | 160 | 150 | 140 |
| EX5-PL4 at | Delta G′ (Pa) | 10689.4 | 14440.6 | 20735.8 | 30040.25 | 42182.95 | 59334.2 | 83793.2 |
| 180° C. | | | | | | | | |
| EX5-PL4 at | Delta G′ (Pa) | 10735.1 | 14486.3 | 20781.5 | 30085.95 | 42228.65 | 59379.9 | 83838.9 |
| 170° C. | | | | | | | | |

| Mottle | | ≤1.0 |
|---|---|---|
| EX5-PL3 | Temp (° C.) | 200 |
| EX5-PL4 at | Delta G′ (Pa) | −3421 |
| 180° C. | | |
| EX5-PL4at | Delta G′ (Pa) | −3375.3 |
| 170° C. | | |

As illustrated by Table 4, the Delta G′ values obtained when comparing the EX5-PL1 and the EX5-PL4 polymer layers was less than or equal to about 30,000 Pa when the DMTA testing temperature of the EX5-PL1 polymer layer was equal to or greater than about 160° C. (and the temperature of the EX5-PL4 polymer layer being about 170° C. or 180° C.). It was estimated that the mottle values of interlayers formed with the EX5-PL1 and EX5-PL4 polymer layers were equal to or less than 1.0 when the DMTA testing temperature of the EX5-PL1 polymer layer was equal to or greater than about 160° C. Contrastingly, it was estimated that the mottle values of interlayers formed with the EX5-PL1 and EX5-PL4 polymer layers were greater than 1.0 when the DMTA testing temperature of the EX5-PL1 polymer layer was less 160° C. As such, the Delta G′ values and corresponding estimated mottle values of Table 4 illustrate that interlayers formed with the EX5-PL1 and EX5-PL4 polymer layers have preferred mottle values (i.e., less than or equal to 1.0) when the Delta G′ value was less than or equal to about 30,000 Pa. In contrast, Table 4 illustrates that interlayers formed with the EX5-PL1 and EX5-PL4 polymer layers have non-preferred mottle values (i.e., greater than 1.0) when the Delta G′ value was greater than or equal to about 50,000 Pa.

As further illustrated by Table 4, the Delta G′ values obtained when comparing the EX5-PL2 and the EX5-PL4 polymer layers was less than or equal to about 42,000 Pa when the DMTA testing temperature of the EX5-PL2 polymer layer was equal to or greater than about 160° C. (and the temperature of the EX5-PL4 polymer layer about 170° C. or 180° C.). It was estimated that the mottle values of interlayers formed with the EX5-PL2 and EX5-PL4 polymer layers were equal to or less than 1.0 when the DMTA testing temperature of the EX5-PL2 polymer layer was equal to or greater than about 160° C. Contrastingly, it was estimated that the mottle values of interlayers formed with the EX5-PL2 and EX5-PL4 polymer layers were greater than 1.0 when the DMTA testing temperature of the EX5-PL2 polymer layer was less 160° C. As such, the Delta G′ values and corresponding estimated mottle values of Table 4 illustrate that interlayers formed with the EX5-PL2 and EX5-PL4 polymer layers have preferred mottle values when the Delta G′ value was less than or equal to about 42,000 Pa. In contrast, Table 4 illustrate that interlayers formed with the EX5-PL2 and EX5-PL4 polymer layers have non-preferred mottle values when the Delta G′ value was greater than or equal to about 60,000 Pa.

As further illustrated by Table 4, the Delta G′ values obtained when comparing the EX5-PL3 and the EX5-PL4 polymer layers was less than or equal to about-3,300 Pa when the DMTA testing temperature of the EX5-PL3 polymer layer was equal to about 200° C. (and the temperature of the EX5-PL4 polymer layer being about 170° C. or 180° C.). It was estimated that the mottle values of interlayers formed with the EX5-PL3 and EX5-PL4 polymer layers were equal to or less than 1.0 when the DMTA testing temperature of the EX5-PL3 polymer layer was equal to or greater than about 200° C. As such, the Delta G′ values and corresponding estimated mottle values of Table 4 illustrate that interlayers formed with the EX5-PL3 and EX5-PL4 polymer layers have preferred mottle values when the Delta G′ value was less than or equal to about −3,300 Pa. As was discussed above, negative Delta G′ values are indicative of the EX5-PL4 polymer layer (i.e., the core layer) being stiffer than the EX5-PL3 polymer layer (i.e., the skin layer). The above-described preferred mottle value of a polymer interlayer comprising EX5-PL3 and EX5-PL4 polymer layers likely resulted, at least in part, because the negative Delta G′ value indicates that the EX5-PL3 polymer layer (the skin layer) is softer than the EX5-PL4 polymer layer (i.e., the core layer) and, thus, the ability of the EX5-PL3 polymer layer to imprint its melt fracture onto the EX5-PL4 polymer layer is reduced.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, or characteristics given for any single component of the present disclosure can be used interchangeably with any ranges, values or characteristics given for any of the other components of the disclosure, where compatible, to form an embodiment having defined values for each of the components, as given herein throughout. For example, a polymer layer can be formed comprising plasticizer content in any of the ranges given in addition to any of the ranges given for residual hydroxyl content, where appropriate, to form many permutations that are within the scope of the present invention but that would be cumbersome to list.

1. A polymer interlayer that resists formation of optical defects, the polymer interlayer comprising:
a first polymer layer; and
a second polymer layer;
wherein said first polymer layer is disposed on a first side of said second polymer layer,
wherein a non-embossed surface of the first side of said second polymer layer includes a surface roughness, defined by an R_{Z} value, of greater than 40 microns,
wherein said polymer interlayer has a mottle value of less than 1.0.

2. A polymer interlayer that resists formation of optical defects, the polymer interlayer comprising:
a first polymer layer; and
a second polymer layer;
wherein said first polymer layer is disposed on a first side of said second polymer layer,
wherein a surface of the first side of said second polymer layer includes a surface roughness, defined by an R_{SM} value, of greater than 500 microns,
wherein said polymer interlayer has a mottle value of less than 1.0.

3. The polymer interlayer of claim 1, wherein the surface roughness is a regular pattern surface roughness formed by melt fracture.

4. The polymer interlayer of claim 1, wherein the R_{Z} value is greater than 50, 60, or 70 microns, and/or wherein the R_{Z} value is between than 40 and 70, 40 and 60, 40 and 50, 50 and 70, 50 and 60, or 60 and 70 microns.

5. The polymer interlayer of claim 1, wherein a surface of the first side of said second polymer layer includes a surface roughness, defined by an R_{SM} value, of greater than 500 microns.

6. The polymer interlayer of claim 1, wherein the R_{SM} value is greater than 600, 700, or 800 microns, and/or wherein the R_{SM} value is between 500 and 800, 500 and 700, 500 and 600, 600 and 800, 600 and 700, or 700 and 800 microns.

7. The polymer interlayer of claim 1, wherein the mottle value is less than 0.9, 0.8, 0.7, 0.6, or 0.5, and/or wherein the mottle value is between 0.5 to 1.0, 0.5 to 0.9, 0.5 to 0.8.

8. The polymer interlayer of claim 1, wherein the first polymer layer has a first storage modulus, wherein the second polymer layer has a second storage modulus, and wherein a difference between the first storage modulus and the second storage modulus is less than about 45,000 Pa, less than 40,000 Pa, less than 35,000 Pa, less than 30,000 Pa, less than 25,000 Pa, less than 20,000 Pa, less than 15,000 Pa, less than 10,000 Pa, or less than 5,000 Pa.

9. The polymer interlayer of claim 1, further comprising a third polymer layer, wherein said first polymer layer is positioned between said second polymer layer and said third polymer layer.

10. The polymer interlayer of claim 1, wherein a thickness of said first polymer layer is generally constant along a length of said polymer interlayer.

11. The polymer interlayer of claim 1, wherein a thickness of said first polymer layer varies along a length of said polymer interlayer, such that said first polymer layer has a wedge shape.

12. A method of forming a polymer interlayer that resists formation of optical defects, said method comprising the steps of:
(a) extruding a first polymer layer through a co-extrusion die;
(b) extruding a second polymer layer through the co-extrusion die; and
(c) extruding a third polymer layer through the co-extrusion die;
wherein upon said extruding of steps (a), (b), and (c), the first polymer layer is positioned between the second and third polymer layers,
wherein during said extruding of step (a) said first polymer layer has a first storage modulus value, wherein during said extruding of step (b) said second polymer layer has a second storage modulus value, and wherein a difference between the first storage modulus value and the second storage modulus value is less than about 45,000 Pa,
wherein upon said extruding of steps (a), (b), and (c), the polymer interlayer has a mottle value of less than 1.0.

13. The method of claim 12, wherein the difference between the first storage modulus value and the second storage modulus value is less than 40,000 Pa, less than 35,000 Pa, less than 30,000 Pa, less than 25,000 Pa, less than 20,000 Pa, less than 15,000 Pa, less than 10,000 Pa, or less than 5,000 Pa.

14. The method of claim 12, wherein the surface roughness of a surface of the second polymer layer is defined by an R_{Z} value, wherein the R_{Z} value is greater than 40, 50, 60, or 70 microns, and/or wherein the R_{Z} value is between than 40 and 70, 40 and 60, 40 and 50, 50 and 70, 50 and 60, or 60 and 70 microns.

15. The method of claim 12, wherein the surface roughness of a surface of the second polymer layer is defined by an R_{SM} value, wherein the R_{SM} value is greater than 500, 600, 700, or 800 microns, and/or wherein the R_{SM} value is between 500 and 800, 500 and 700, 500 and 600, 600 and 800, 600 and 700, or 700 and 800 microns.

16. The method of claim 12, wherein the mottle value is less than 0.9, 0.8, 0.7, 0.6, or 0.5, and/or wherein the mottle value is between 0.5 to 1.0, 0.5 to 0.9, 0.5 to 0.8.

17. The method of claim 12, wherein said extruding of steps (a), (b), and (c) are performed simultaneously.

18. The method of claim 17, wherein said extruding of steps (a), (b), and (c) are performed via co-extrusion.

19. A polymer interlayer that resists formation of optical defects, where said polymer interlayer is formed according to the method of claim 12.
